(19) United States
(12) Patent Application Publication
(10) Pub. No.: US 2019/0117022 A1
(43) Pub. Date: Apr. 25, 2019

(54) Heated Scooping Device

(71) Applicant: John Connally, Clarksville, TX (US)

(72) Inventor: John Connally, Clarksville, TX (US)

(21) Appl. No.: 15/791,941

(22) Filed: Oct. 24, 2017

(51) Int. Cl. A47J 43/28

(52) U.S. Cl. CPC A47J 43/282

(57) ABSTRACT

A heated scooping device for dispensing ice cream includes a tube that has a first end, which is closed. A shell, which is cup shaped, is fluidically coupled to a second end of the tube. A connector that is coupled to the first end of the tube is configured to couple to a source of alternating current. A heating element that is positioned in the tube and the shell is electrically insulated from the tube and the shell and is operationally coupled to the connector. The tube is configured to be grasped in a hand of a user so that the shell is configured to insert into a substance that is positioned in a container, such as ice cream. The heating element is configured to warm the tube and the shell so that the shell is configured to melt the substance to facilitate removal of a portion of the substance.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to scooping devices and more particularly pertains to a new scooping device for dispensing ice cream.

### BRIEF SUMMARY OF THE INVENTION

An embodiment of the disclosure meets the needs presented above by generally comprising a tube that has a first end, which is closed. A shell, which is cup shaped, is fluidically coupled to a second end of the tube. A connector that is coupled to the first end of the tube is configured to couple to a source of alternating current. A heating element that is positioned in the tube and the shell is electrically insulated from the tube and the shell and is operationally coupled to the connector. The tube is configured to be grasped in a hand of a user so that the shell is configured to insert into a substance that is positioned in a container, such as ice cream. The heating element is configured to warm the tube and the shell so that the shell is configured to melt the substance to facilitate removal of a portion of the substance.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a heated scooping device according to an embodiment of the disclosure.

FIG. 2 is a side view of an embodiment of the disclosure.

FIG. 3 is a bottom view of an embodiment of the disclosure.

FIG. 4 is a cross-sectional view of an embodiment of the disclosure.

FIG. 5 is a detail view of an embodiment of the disclosure.

### DETAILED DESCRIPTION OF THE INVENTION

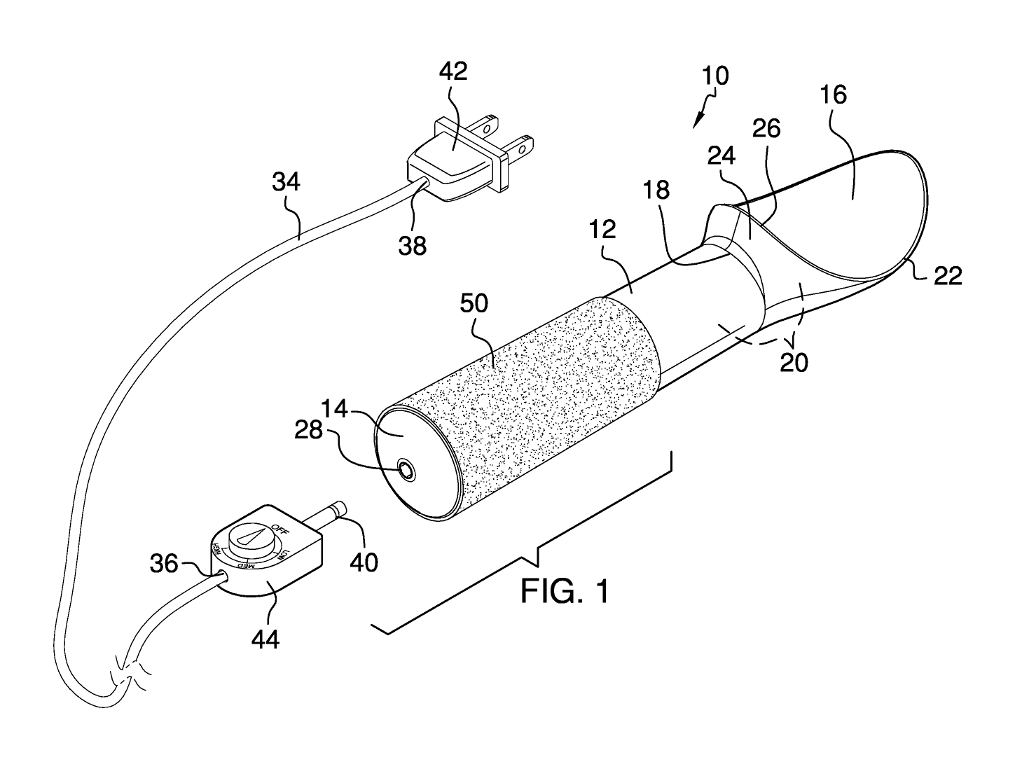

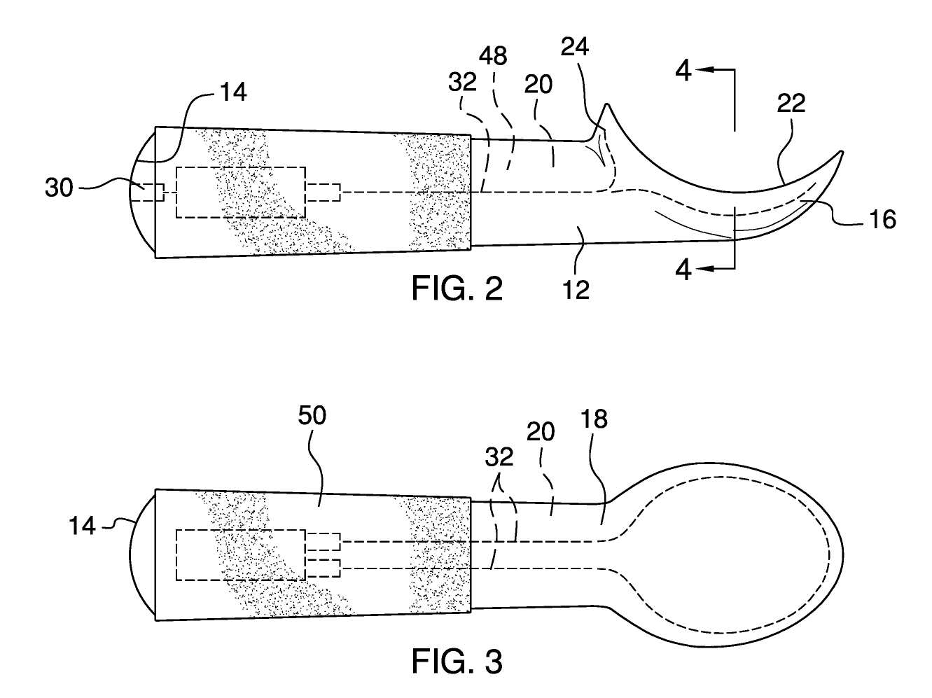

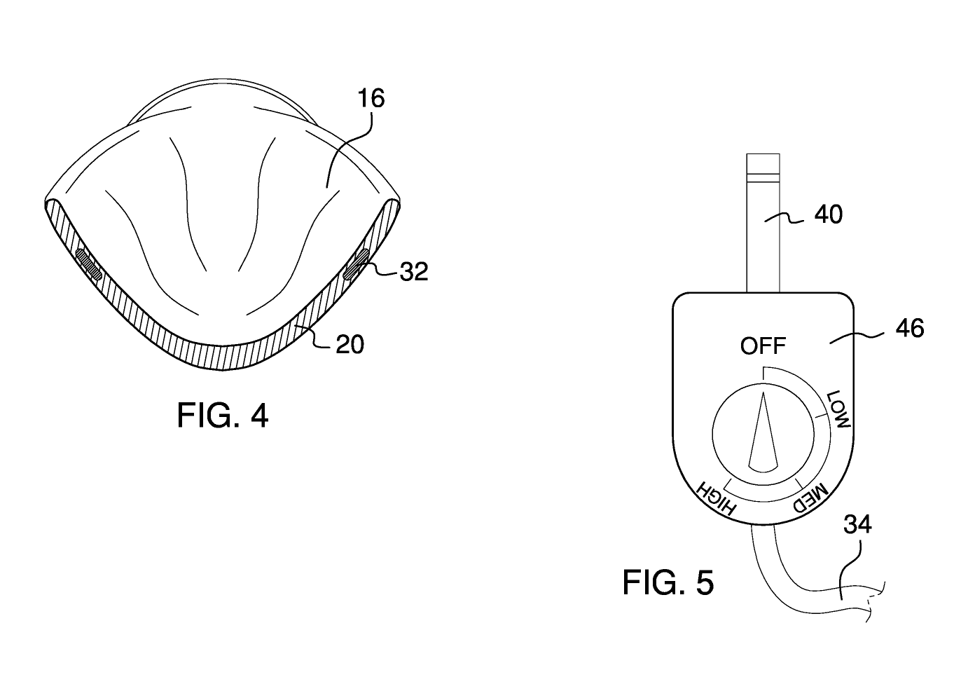

With reference now to the drawings, and in particular to FIGS. 1 through 5 thereof, a new scooping device embodying the principles and concepts of an embodiment of the disclosure and generally designated by the reference numeral 10 will be described.

As best illustrated in FIGS. 1 through 5, the heated scooping device 10 generally comprises a tube 12 that has a first end 14, which is closed. In one embodiment, the tube 12 is circularly shaped when viewed longitudinally.

A shell 16 is fluidically coupled to a second end 18 of the tube 12. The tube 12 and the shell 16 define an interior space 20. The shell 16 is cup shaped. The tube 12 is configured to be grasped in a hand of a user so that the shell 16 is configured to insert into a substance that is positioned in a container, such as ice cream, to remove a portion of the substance from the container. The shell 16 has an upper perimeter 22. In one embodiment, the upper perimeter 22 is arcuate distal from the shell 16.

A protrusion 24 is coupled to and extends from the upper perimeter 22 adjacent to the tube 12. The protrusion 24 is configured to curl the portion of the substance as the shell 16 is inserted into the substance that is positioned in the container. The protrusion 24 has an upper edge 26. In one embodiment, the upper edge 26 is arcuate.

A connector 28 is coupled to the first end 14 of the tube 12. The connector 28 is configured to couple to a source of alternating current. In one embodiment, the connector 28 comprises a port 30.

A heating element 32 is positioned in the interior space 20. The heating element 32 is electrically insulated from the tube 12 and the shell 16. The heating element 32 is operationally coupled to the connector 28. The heating element 32 is configured to warm the tube 12 and the shell 16. The shell 16 is configured to melt the substance to facilitate the removal of the portion of the substance from the container.

The device 10 comprises a cord 34 that has a first terminus 36 and a second terminus 38. A first plug 40 is coupled to the first terminus 36 of the cord 34. The first plug 40 is complementary to the port 30. The port 30 is positioned to selectively insert the first plug 40 to operationally couple the cord 34 to the heating element 32.

A second plug 42 is coupled to the second terminus 38 of the cord 34. The second plug 42 is configured to selectively insert into an electrical socket. In one embodiment, the second plug 42 is complementary to a Type A electrical socket.

A controller 44 is positioned in the cord 34 proximate to the first terminus 36. The controller 44 is positioned to regulate a level of a current that enters the heating element 32 to control the warming of the tube 12 and the shell 16. In one embodiment, the controller 44 comprises a thermostat 46 that has off, high, medium, and low setpoints.

In one embodiment, a fluid 48 is positioned in the interior space 20. The fluid 48 is thermally conductive. The fluid 48 is positioned to transfer heat from the heating element 32 to the shell 16 and the tube 12.

A grip 50 is coupled to the tube 12. The grip 50 is positioned proximate to the first end 14 of the tube 12. The grip 50 is configured to insulate the hand of the user that grasps the tube 12.

In use, the tube 12 is configured to be grasped in the hand of the user. The shell 16 is configured to insert into the substance that is positioned in the container, such as the ice cream, to remove the portion of the substance from the container. The protrusion 24 is configured to curl the portion of the substance as the shell 16 is inserted into the substance that is positioned in the container. The heating element 32 is configured to warm the tube 12 and the shell 16. The shell 16 is configured to melt the substance to facilitate the removal of the portion of the substance from the container. The fluid 48 is positioned to transfer heat from the heating element 32 to the shell 16 and the tube 12. The controller 44 is positioned to regulate the level of the current that enters the heating element 32 to control the warming of the tube 12 and the shell 16. The grip 50 is configured to insulate the hand of the user that grasps the tube 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heated scooping device comprising:
a tube having a first end, said first end being closed;
a shell fluidically coupled to a second end of said tube such that said tube and said shell define an interior space, said shell being cup shaped;
a connector coupled to said first end of said tube, said connector being configured for coupling to a source of alternating current;
a heating element positioned in said interior space, said heating element being electrically insulated from said tube and said shell, said heating element being operationally coupled to said connector; and
wherein said tube is positioned on said shell such that said tube is configured for grasping in a hand of a user such that said shell is configured for inserting into a substance positioned in a container, such as ice cream, for removing a portion of the substance from the container, wherein said heating element is positioned in said interior space such that said heating element is configured for warming said tube and said shell such that said shell is configured for melting the substance for facilitating removing the portion of the substance from the container.

2. The device of claim 1, further including said tube being circularly shaped when viewed longitudinally.

3. The device of claim 1, further including said shell having an upper perimeter, said upper perimeter being arcuate distal from said shell.

4. The device of claim 3, further including a protrusion coupled to and extending from said upper perimeter adjacent to said tube, wherein said protrusion is positioned on said shell such that said protrusion is configured for curling the portion of the substance as said shell is inserted into the substance positioned in the container.

5. The device of claim 4, further including said protrusion having an upper edge, said upper edge being arcuate.

6. The device of claim 1, further comprising:
said connector comprising a port;
a cord having a first terminus and a second terminus;
a first plug coupled to said first terminus of said cord, said first plug being complementary to said port;
a second plug coupled to said second terminus of said cord, said second plug being configured for selectively inserting into an electrical socket; and
wherein said first plug is positioned on said cord such that said port is positioned for selectively inserting said first plug for operationally coupling said cord to said heating element.

7. The device of claim 6, further including said second plug being complementary to a Type A electrical socket.

8. The device of claim 6, further including a controller positioned in said cord proximate to said first terminus, wherein said controller is positioned in said cord such that said controller is positioned for regulating a level of a current entering said heating element for controlling the warming of said tube and said shell.

9. The device of claim 8, further including said controller comprising a thermostat having off, high, medium, and low setpoints.

10. The device of claim 1, further including a fluid positioned in said interior space, said fluid being thermally conducting, wherein said fluid is positioned in said interior space such that said fluid is positioned for transferring heat from said heating element to said shell and said tube.

11. The device of claim 1, further including a grip coupled to said tube, said grip being positioned proximate to said first end of said tube, wherein said grip is positioned on said tube such that said grip is configured for insulating the hand of the user grasping said tube.

12. A heated scooping device comprising:
a tube having a first end, said first end being closed, said tube being circularly shaped when viewed longitudinally;
a shell fluidically coupled to a second end of said tube such that said tube and said shell define an interior space, said shell being cup shaped, wherein said tube is positioned on said shell such that said tube is configured for grasping in a hand of a user such that said shell is configured for inserting into a substance positioned in a container, such as ice cream, for removing a portion of the substance from the container, said shell having an upper perimeter, said upper perimeter being arcuate distal from said shell;
a protrusion coupled to and extending from said upper perimeter adjacent to said tube, wherein said protrusion is positioned on said shell such that said protrusion is configured for curling the portion of the substance as said shell is inserted into the substance positioned in the container, said protrusion having an upper edge, said upper edge being arcuate;
a connector coupled to said first end of said tube, said connector being configured for coupling to a source of alternating current, said connector comprising a port;
a heating element positioned in said interior space, said heating element being electrically insulated from said tube and said shell, said heating element being operationally coupled to said connector, wherein said heating element is positioned in said interior space such that said heating element is configured for warming said tube and said shell such that said shell is configured for melting the substance for facilitating removing the portion of the substance from the container;
a cord having a first terminus and a second terminus;
a first plug coupled to said first terminus of said cord, said first plug being complementary to said port, wherein said first plug is positioned on said cord such that said port is positioned for selectively inserting said first plug for operationally coupling said cord to said heating element;
a second plug coupled to said second terminus of said cord, said second plug being configured for selectively inserting into an electrical socket, said second plug being complementary to a Type A electrical socket;
a controller positioned in said cord proximate to said first terminus, wherein said controller is positioned in said cord such that said controller is positioned for regulating a level of a current entering said heating element for controlling the warming of said tube and said shell, said controller comprising a thermostat having off, high, medium, and low setpoints;
a fluid positioned in said interior space, said fluid being thermally conducting, wherein said fluid is positioned in said interior space such that said fluid is positioned for transferring heat from said heating element to said shell and said tube;
a grip coupled to said tube, said grip being positioned proximate to said first end of said tube, wherein said grip is positioned on said tube such that said grip is configured for insulating the hand of the user grasping said tube; and
wherein said tube is positioned on said shell such that said tube is configured for grasping in the hand of the user such that said shell is configured for inserting into the substance positioned in the container, such as the ice cream, for removing the portion of the substance from the container, wherein said protrusion is positioned on said shell such that said protrusion is configured for curling the portion of the substance as said shell is inserted into the substance positioned in the container, wherein said heating element is positioned in said interior space such that said heating element is configured for warming said tube and said shell such that said shell is configured for melting the substance for facilitating removing the portion of the substance from the container, wherein said fluid is positioned in said interior space such that said fluid is positioned for transferring heat from said heating element to said shell and said tube, wherein said controller is positioned in said cord such that said controller is positioned for regulating the level of the current entering said heating element for controlling the warming of said tube and said shell, wherein said grip is positioned on said tube such that said grip is configured for insulating the hand of the user grasping said tube.
